(19) United States
(12) Patent Application Publication
(10) Pub. No.: US 2011/0140651 A1
(43) Pub. Date: Jun. 16, 2011

(54) RECHARGEABLE LEAD-ACID BATTERY COVER

(76) Inventor: Alex DAI, Dadu Township (TW)

(21) Appl. No.: 12/636,724

(22) Filed: Dec. 12, 2009

(51) Int. Cl. H02J 7/00

(52) U.S. Cl. 320/107

(57) ABSTRACT

A rechargeable lead-acid battery cover has a casing, two power outlet line through-holes, a circuit board and a charging assembly seat. The casing is provided with a holding space, and the power outlet line through-holes are set at one side of the holding space for penetration of anode and cathode leads, and also for electrical connection with the positive/negative contacts of the lead-acid battery. The circuit board is assembled into the casing's holding space, and connected to the positive and negative contacts through anode and cathode supply lines. A charging assembly seat is set on the circuit board and also electrically connected with anode and cathode supply lines, while the charging assembly seat is connected with a charging power source, and the lead-acid battery is charged through anode and cathode supply lines. The lead-acid battery can be protected and the charging function can be guaranteed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a lead-acid battery cover, and more particularly to an innovative one which is provided with charging functions.

2. Description of Related Art Including Information Disclosed Under 37 CFR 1.97 and 37 CFR 1.98.

The human life is closely related to lead-acid batteries with S&T progress, since such batteries are extensively used in a variety of devices and emergency power supply products due to superior life.

However, the common lead-acid battery for emergency power supply is accommodated into an external enclosure, which is fitted with a charging seat enabling rechargeable power supply by the lead-acid battery. Due to imperfect configuration of the external enclosure, there exist some disadvantages to the lead-acid battery. These include oversizing, poorer flexibility and adverse environmental impact. Thus, there is still a big room for improvement.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique configuration of the present invention that the cover is provided with a charging assembly seat, this enables the cover to fully seal the positive/negative contacts of the lead-acid battery to avoid any contact hazards, and also provide charging functions. With this configuration, thus, this compact rechargeable cover can help improve the flexibility and environmental friendliness to meet the diversified user demands with improved applicability and industrial benefits.

The improvements brought about by this invention are as follows:

Based on the structural configuration wherein the cover includes a power supply assembly seat, power indicator light, charging indicator light and light-emitting module, the lead-acid battery can realize illuminance through the light-emitting unit of the light-emitting module, and also provide power through the power supply assembly seat. Moreover, the cover allows the power indicator light and charging indicator light to indicate the power and charging state of the lead-acid battery, thus shaping a multifunctional cover to meet the diversified user demands.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the lead-acid battery and cover of the present invention.

FIG. 2 shows an exploded perspective view of the lead-acid battery and cover of the present invention.

FIG. 3 shows an exploded perspective view of the cover and circuit board of the present invention.

FIG. 4 shows a cross sectional view of the assembled lead-acid battery and multifunctional cover of the present invention.

FIG. 5 shows a schematic view of the present invention wherein the charging assembly seat is connected with a charging power source.

FIG. 6 shows a schematic view of the present invention wherein the cover includes a power supply assembly seat.

### DETAILED DESCRIPTION OF THE INVENTION

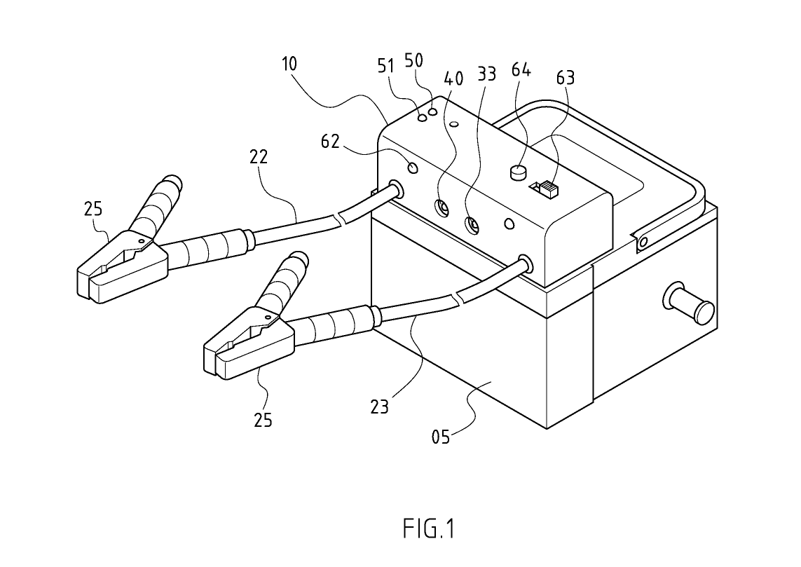

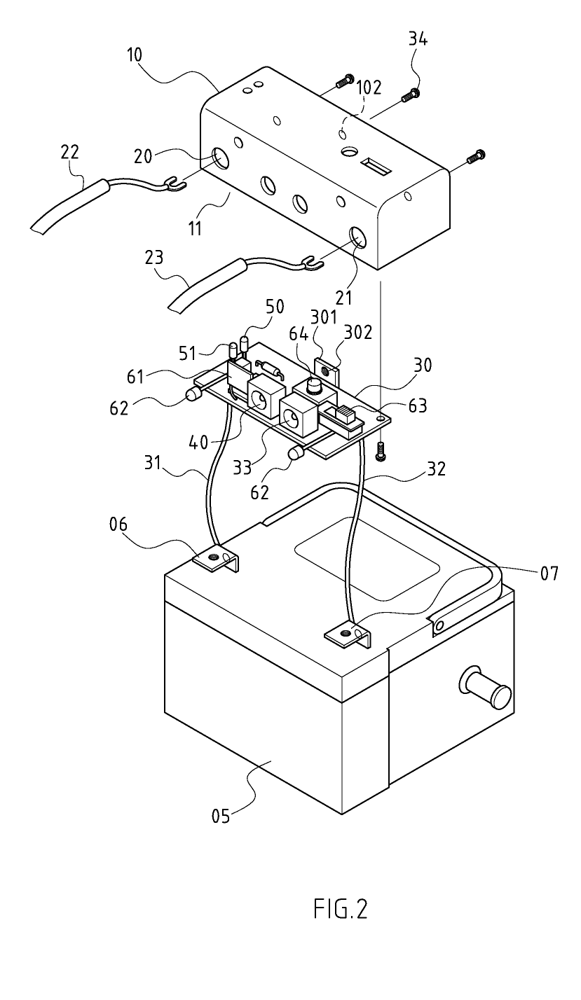

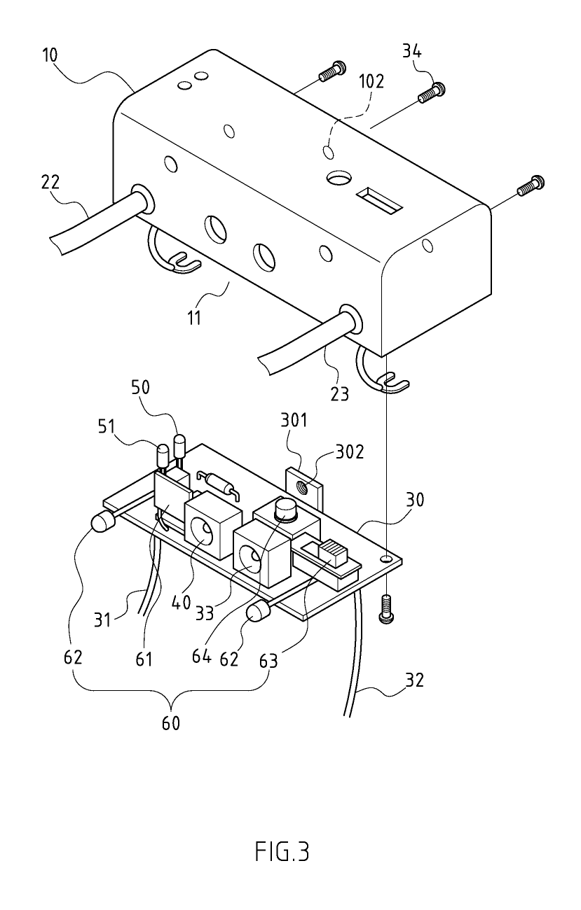

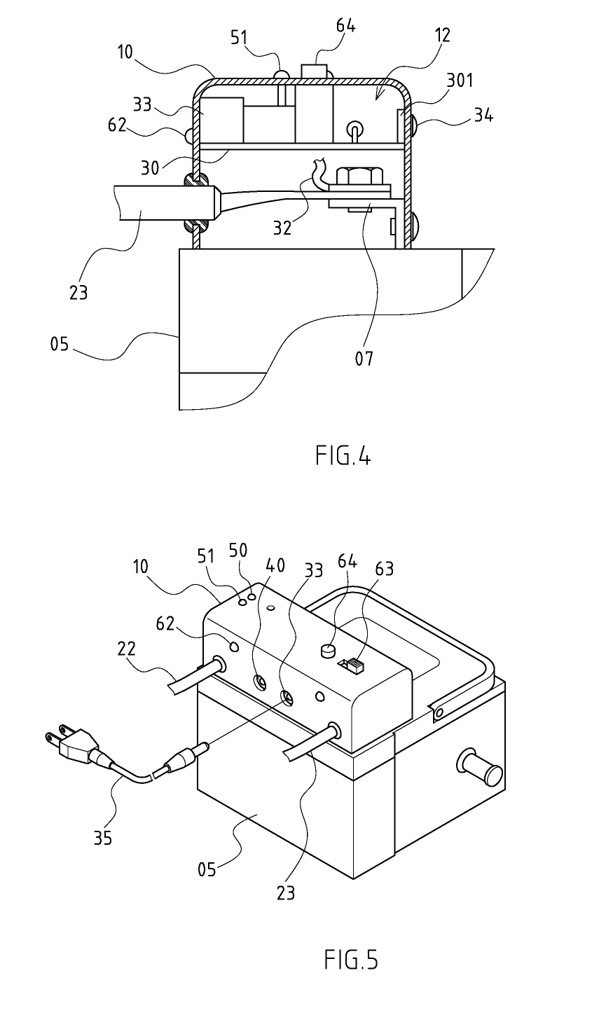

FIGS. 1-4 depict preferred embodiments of a rechargeable lead-acid battery cover of the present invention, which are provided for only explanatory objective for patent claims. Said cover is assembled onto the positive, negative contacts 06, 07 of existing lead-acid battery 05. Said cover includes a casing 10, with a casing outlet 11 set at the bottom and a holding space 12 set in the casing 10. Two power outlet line through-holes 20, 21, are set at one side of the holding space 12 for penetration of anode and cathode leads 22, 23 of the power outlet line 25. Moreover, the anode and cathode leads 22, 23 firstly penetrate into the holding space 12 from two power outlet line through-holes 20, 21, and then pass through the casing outlet 11 of the casing 10 to connect electrically with the positive, negative contacts 06, 07 of the lead-acid battery 05.

A circuit board 30 is assembled into the holding space 12 of the casing 10. The circuit board 30 is connected to the positive, negative contacts 06, 07 of the lead-acid battery 05 via anode and cathode supply lines 31, 32; the circuit board 30 and the casing 10 are assembled in such a manner that a lug 301 is protruded from one side of the circuit board 30. The lug 301 is provided with a tap hole 302 corresponding to the through-hole 102 at one side of the casing 10, so a bolt 34 passes the through-hole 102 and then is screwed into the tap hole 302 to locate fixedly the assembly of the circuit board 30 and the casing 10.

A charging assembly seat 33 is arranged onto the circuit board 30 and connected electrically with the anode and cathode supply lines 31, 32. The charging assembly seat 33 is used for connection with a charging power source 35 (disclosed in FIG. 5), and then the lead-acid battery 05 is charged through the anode and cathode supply lines 31, 32.

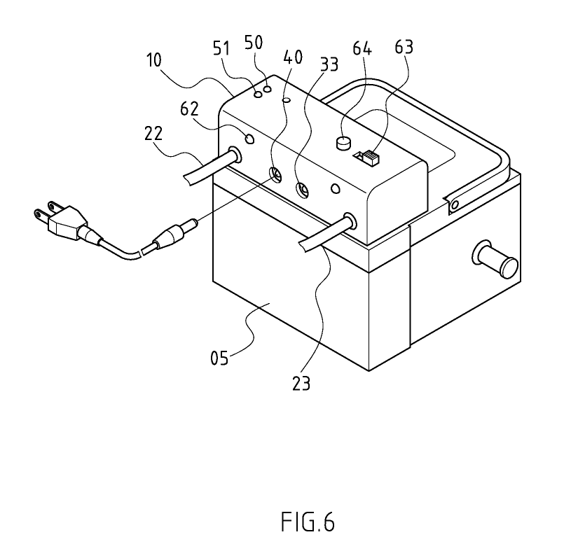

Referring to FIG. 6, the cover also includes a power supply assembly seat 40, which is connected electrically with the anode and cathode supply lines 31, 32, and an electric appliance is linked via the power supply assembly seat 40 for output of power supply less than 5A. This can be combined differently depending on the actual output requirements.

Amongst traditional single or multiple battery indicators, the power strength of multiple ones is ascertained from the light output, but this will lead to power consumption. Conversely, a check button is required by the single indicator to judge the presence or otherwise of the power, but it is difficult to indicate automatically the power strength for the users. In order to resolve the aforementioned problems, the cover of the present invention is fitted with a power indicator light 51 and a charging indicator light 50. The power indicator light 51 and the charging indicator light 50 are protruded from one side of the casing 10, and also electrically connected with a control circuit 61 of a light-emitting module 60. The power indicator light 51 can indicate the power state of the lead-acid battery 05, allowing to charge it properly and prevent crystallization of lead sulfate against the service life arising from the idle state of battery 05 plate. The charging indicator light 50 with two colors permits to change the color of lights when the lead-acid battery 05 is charged or the charging is finished.

Of which, the cover includes a light-emitting module 60 set on the circuit board 30. The light-emitting module 60 includes a control circuit 61, at least a light-emitting unit 62, a switch 63 used to control the switching-on/-off of the light-emitting unit 62, and a multi-segment button 64 used to regulate the glow threshold of the light-emitting unit 62. The light-emitting unit 62 is protruded from one side of the casing 10, and the light-emitting unit 62 in the form of LED features high illuminance, energy-savings and lower cost, enabling to provide necessary lighting in the dark or obscure environment. The multi-segment button 64 allows to switch continuous highlighting or flashing of the light-emitting unit 62.

Based on the above-specified structural configuration, the core of the lead-acid battery cover of the present invention lies in that, the cover is provided with the circuit board 30 and charging assembly seat 33, and the charging assembly seat 33 is set on the circuit board 30, so the cover can fully seal the positive, negative contacts 06, 07 of the lead-acid battery 05 to avoid any contact hazards, and also provide charging functions. Thus, this compact rechargeable cover can help improve the flexibility and environmental friendliness to meet the diversified user demands.

1. A rechargeable lead-acid battery cover, which is assembled onto the positive and negative contacts of an existing lead-acid battery; said cover comprising:
a casing; with a casing outlet set at a bottom thereof; and a holding space is set in the casing;
two power outlet line through-holes; set at one side of the holding space for penetration of anode and cathode leads of a power outlet line; moreover, the anode, and cathode leads firstly penetrate into the holding space from the two power outlet line through-holes, and then pass through the casing outlet to connect electrically with the positive, and negative contacts of the lead-acid battery;
a circuit board; assembled into the holding space of the casing; the circuit board is connected to the positive and negative contacts of the lead-acid battery via anode and cathode supply lines;
a charging assembly seat; arranged onto the circuit board and connected electrically with the anode and cathode supply lines; the charging assembly seat is used for connection with a charging power source, and then the lead-acid battery is charged through the anode and cathode supply lines;
a power supply assembly seat; which is connected electrically with the anode and cathode supply lines;
a light-emitting module; set on the circuit board; the light-emitting module comprises a control circuit, at least a light-emitting unit, a switch used to control the switching on and off of the light-emitting unit and a multi-segment button used to regulate the glow threshold of the light-emitting unit; the light-emitting unit is protruded from one side of the casing;
a power indicator light; protruded from a preset location of the casing, and also electrically connected with the control circuit of light-emitting module; and
a charging indicator light, protruded from a preset location of the casing, and also electrically connected with the control circuit of light-emitting module.
